(19) United States
(12) Patent Application Publication
(10) Pub. No.: US 2019/0100539 A1
(43) Pub. Date: Apr. 4, 2019

(54) POLYARYLATION OF POLYHEDRAL BORANES

(71) Applicant: THE CURATORS OF THE UNIVERSITY OF MISSOURI, Columbia, MO (US)

(72) Inventor: Mark W. Lee, Jr., Columbia, MO (US)

(73) Assignee: THE CURATORS OF THE UNIVERSITY OF MISSOURI, Columbus, MO (US)

(21) Appl. No.: 16/082,658

(22) PCT Filed: Mar. 6, 2017
(86) PCT No.: PCT/US2017/020963

§ 371 Date: Sep. 6, 2018

Related U.S. Application Data
(60) Provisional application No. 62/307,331, filed on Mar. 11, 2016.

(51) Int. Cl. C07F 5/05

(52) U.S. Cl. CPC C07F 5/05

(57) ABSTRACT

A polyarylborane comprising a substituted polyhedral borane comprising at least 3 exohedrally bonded aryl groups, wherein the substituted polyhedral borane is homo- or hetero-, and each exohedrally bonded aryl group is independently homo- or hetero-, substituted or unsubstituted, and monocyclic or polycyclic. Also, molecules and materials comprising the polyarylborane, and methods for making the polyarylboranes.

### CROSS-REFERENCE TO RELATED APPLICATION

This patent application claims priority to pending U.S. Provisional Patent Application Ser. No. 62/307,331, filed Mar. 11, 2016, and entitled, “POLYARYLATION OF POLYHEDRAL BORANES,” the entire disclosure of which is incorporated herein by reference.

### FIELD OF THE INVENTION

One or more embodiments of the invention relate to polyhedral boranes (boron hydride clusters) and/or carboranes that are polyaryl substituted (i.e., 3 or more aryl substituents) and compounds containing the same, and methods for making the same.

### BACKGROUND OF INVENTION

Since its first isolation nearly sixty years ago, the dodecahydrododecaborate dianion [B₁₂H₁₂]²⁻ (or B12) has served as an extraordinary model for chemical theoreticians and teachers, and as a unique material for experimentalists. The icosahedral structure is a three-dimensionally aromatic species owing to extensive delocalization of its 26 framework bonding electrons. In particular, twenty four of their valence electrons participate in the formation of sigma bonds with the hydrogen atoms bound to the twelve vertices and the aforementioned remaining 26 cage bonding electrons are extensively delocalized among the remaining orbitals of the 12 boron atoms, giving rise to the three dimensional aromatic characteristics of this species. A full explanation of the unique bonding within such boron hydrides, in part, led to the Nobel Prize in chemistry for Lipscomb in 1976.

Immediately following its discovery, efforts began towards developing new substitution chemistry for the dodecahydrododecaborate dianion. Despite its remarkable chemical inertness, one or more of the hydrogen atoms on the cage have been replaced by different exohedrally bonded substituents through the formation of bonds between boron and carbon, oxygen, sulfur, nitrogen, phosphorous, silicon, or halogens. However, such substitution reactions tended to be limited to the placement of one, or two substituents. Polysubstitution (n>3) of the cage hydrogens has typically been limited to halogens, methyl, or hydroxyl groups. Under more forcing conditions, the per-substitution of the cage with these substituents has been accomplished. The hydroxyl groups of perhydroxylated species [B₁₂(OH)₁₂]²⁻ form a reactive sheath upon which to synthesize ethers, esters, carbonates, and carbamates.

Nearly fifty years ago, Muetterties observed that perhalogenated B12 (Cl, Br, I) may be reversibly oxidized through two, one-electron processes to give the stable, hypercloso, 25-electron radical ion and the stable, hypercloso, 24-electron neutral species. Much later, Hawthorne and coworkers prepared and observed this behavior with permethyl and perether dodecaborates. It is hypothesized that the stability of the oxidized hypercloso species is attributed to the supply of electron density from the substituents to the electron deficient cage through π back donation. Observations of the shortening of the B—O bond lengths in the crystal structures of the 24-electron perether substituted B12 support this hypothesis.

In a characteristic similar to that of the perhalo and permethylated derivatives, the perether substituted dodecaborate core is redox active and may be reversibly oxidized through two, one-electron processes to yield the stable, hypercloso, 25-electron radical [B₁₂(O [symbol] and the stable, hypercloso, 24-electron neutral molecule [B₁₂(OR)₁₂].

It has been demonstrated that the reduction potentials for the [B₁₂(OR)₁₂]²⁻/[B₁₂(OR)₁₂]¹⁻ and [B₁₂(OR)₁₂]¹⁻/[B₁₂(OR)₁₂]⁰ oxidation-reduction processes are dependent on the nature of the ether substituents and when combined, range over 1.2 Volts (spanning 0.67 V and 0.70 V, respectively). Furthermore, it has been demonstrated that these potentials may be predicted using linear free energy equations. For example, the reduction potentials for B12 substituted with benzyl ethers may be predicted using Hammett sigma constants and that those for the alkyl ether substituted species may by predicted using the molar refractivity and hydrophobicity (π) substituent constants.

Reports of phenyl (or substituted phenyl) B12 are very limited. In particular, the cage has been substituted with a single benzene ring, prepared from the monoiodinated [B₁₂H₁₁l]²⁻ through a Grignard reaction. The mono and di-substituted B12 were reported using bromobenzene and iodobenzene.

In view of the forgoing, a need still exists for polyaryl substituted polyhedral boranes, including B12, and methods for synthesizing the same.

### SUMMARY OF INVENTION

In one embodiment, the invention is directed to a polyarylborane comprising a substituted polyhedral borane comprising at least 3 exohedrally bonded aryl groups, wherein the substituted polyhedral borane is homo- or hetero-, and each exohedrally bonded aryl group is independently homo- or hetero-, substituted or unsubstituted, and monocyclic or polycyclic.

In another embodiment of the invention is a molecule that comprises at least one of the various polyarylboranes within the scope described above.

Various other embodiments of the invention are a composition, polymer, photocatyst, electroluminescent material, polymerizable monomer, non-linear optical material, or molecular electronic material comprising at least one of the various polyarylboranes within the scope described above or a molecule comprising said polyarylborane.

Another embodiment of the invention is a method of producing the various polyarylboranes within the scope described above, the method comprising heating a reaction mixture that comprises a liquid phase solvent and a solute polyhedral borane in the solvent, wherein the solvent comprises one or more arenes, to react at least one of the polyhedral boranes and at least one of the arenes for a duration sufficient to form the substituted polyhedral borane comprising at least 3 exohedrally bonded aryl groups (the polyarylborane), wherein the polyarylborane is homo- or hetero-, and the arene is homo- or hetero-, substituted or unsubstituted, and monocyclic or polycyclic.

### BRIEF DESCRIPTION OF THE DRAWINGS

FIG. 1 depicts an exemplary reaction between a dodecahydrodecaborate ion and benzene resulting in a product having an average of eight phenyl substituents.

FIG. 2 is a high resolution mass spectrum of products from a reaction between the tetrabutylammonium salt of dodecaborate and benzene.

FIG. 3: top depiction is a reaction between a dodecahydrodecaborate ion and a benzene, fluoro-, chloro- or bromo-, and/or iodobenze, toluene, and phenol; middle depiction is a lack reaction between a dodecahydrodecaborate ion and benzonitrile; bottom depiction is a reaction between a dodecahydrodecaborate ion and naphthalene.

FIG. 4: left is a ball and stick model of an isomer of the 9-fold substituted phenyl product; and right space filling model of the same 9-fold substituted phenyl product. These two models are in the same orientation. In the space filling model, it is apparent that the three remaining hydrogen atoms (one shown) on the B12 cluster are crowded by closely surrounding phenyl groups.

FIG. 5: A contains cyclic voltammograms of the products [B₁₂H₆(C₆H₅)₆]²⁻ and [B₁₂H₅(C₁₀H₇)₇]²⁻ in a 0.1M solution of TBAPF₆ in dichloromethane and a blank voltammogram is shown; B contains a picture of the visible fluorescence emission of [B₁₂H₅(C₁₀H₇)₇]²⁻ in dichloromethane.

### DETAILED DESCRIPTION OF INVENTION

### Introduction

Advantageously, it has been discovered that using mildly elevated temperatures, even in the absence of any catalyst, polyhedral boranes, including dodecaborate [B₁₂H₁₂]^{2-,} decaborate [B₁₀H₁₀]^{2-,} and carboranes [C₂B₁₀H₁₂], directly react with a diverse range of aromatic hydrocarbon molecules (arenes). In particular, the hydrogen atoms attached to boron vertices are replaced with aromatic substituents, forming stable boron-carbon bonds. The degree of cage substitution is readily controllable and has been observed to depend on the reaction time and the temperature employed, as well as the size of the reacting aromatic molecules. Indeed, utilizing short reaction times singly substituted products have been produced, which can be isolated from other products (e.g., by chromatographic separation). Of particular advantage, however, is that the process disclosed herein readily allows for a degree of cage substitution greater than mono- or bi-substitutions (i.e., at least 3 cage substitutions). For example, experiments to date have replaced up to nine of the hydrogen atoms attached to boron vertices of [B₁₂H₁₂]^{2-,} [B₁₀H₁₀]²⁻, and [C₂B₁₀H₁₂] with aromatic substituents.

Such unprecedented polysubstitution reactions produce nanomolecular molecules and ions consisting of a polyhedral borane core bearing several exohedrally bonded aromatic substituents. Examples of molecules which are observed to react with polyhedral boranes in this manner include benzene, a wide range of substituted benzenes, polycyclic aromatic hydrocarbons, and aromatic heterocycles. The resulting polysubstituted polyhedral boranes tend to have interesting structural, electronic, and spectroscopic properties. For example, without being held to a particular theory, spectroscopic studies performed thus far indicate that these exohedral substituents are in electronic communication with the polyhedral borane core, resulting in a new class of materials exhibiting high solution-phase photoluminescence (PL) quantum efficiencies.

This new class of hybrid organic/inorganic nanomolecular molecules and ions having at least three aromatic substituents is designated as “polyarylboranes,” regardless of whether the arenes or aryl groups are substituted or not. It is to be noted that various embodiments of the present invention are involve heteroboranes such as carboranes like [C₂B₁₀H₁₂]. Although it is intended that the term “polyarylboranes” encompasses such embodiments, such embodiments may also be referred to as “polyarylcarboranes.”

### Definitions

As used herein, the term “borane” means a chemical compound consisting of boron and hydrogen atoms, exclusive of any pendant group atoms.

As used herein, the term “carborane” means a chemical compound consisting of boron, hydrogen, and carbon atoms, exclusive of any pendant group atoms.

The terms “alkyl”, “alkenyl”, “alkoxy”, “aminoalkyl”, “aminoalkenyl”, “aminoalkoxy”, “cycloalkyl”, “aryl”, and “phenyl” refer to both substituted and unsubstituted and both branched an unbranched, where applicable, alkyl, alkenyl, alkoxy, aminoalkyl, aminoalkenyl, aminoalkoxy, cycloalkyl, aryl, and phenyl groups.

As used herein, the term “substituted” refers to replacement of one or more hydrogen atoms on a given group with one or more of a cyano, hydroxyl, hydroxyalkyl, nitro, halogen, amino, carboxyl, or —CO—NH₂ group.

Further, the term “alkyl” refers to inclusive, linear, branched, or cyclic, saturated or unsaturated (i.e., alkenyl and alkynyl) hydrocarbon chains. The alkyl group can be optionally substituted with one or more alkyl group substituents which can be the same or different, where “alkyl group substituent” includes alkyl, halo, arylamino, acyl, hydroxyl, aryloxy, alkoxyl, alkylthio, arylthio, aralkyloxy, aralkylthio, carboxy, alkoxycarbonyl, oxo and cycloalkyl. There can be optionally inserted along the alkyl chain one or more oxygen, sulfur or substituted nitrogen atoms, wherein the nitrogen substituent is hydrogen, lower alkyl (also referred to herein as “alkylaminoalkyl”), or aryl. “Branched” refers to an alkyl group in which a lower alkyl group, such as methyl, ethyl or propyl, is attached to linear alkyl chain.

“Cyclic” and “cycloalkyl” refer to a non-aromatic mono- or multi-cyclic ring system of about 3 to about 10 carbon atoms. The cycloalkyl group can be optionally partially unsaturated. The cycloalkyl group can be also optionally substituted with an alkyl group substituent as defined herein, ox and/or alkylene. There can be optionally inserted along the cyclic alkyl chain one or more oxygen, sulfur or substituted nitrogen atoms, wherein the nitrogen substituent is hydrogen, lower alkyl, or aryl, thus providing a heterocyclic group.

As used herein, the term “alkylene” shall denote a divalent group formed by removing two hydrogen atoms from a hydrocarbon, the free valencies of which are not engaged in a double bond, and may include heteroatoms. The alkylene group can be straight, branched or cyclic. The alkylene group can be also optionally unsaturated and/or substituted with one or more “alkyl group substituents.” There can be optionally inserted along the alkylene group one or more oxygen, sulfur or substituted nitrogen atoms, wherein the nitrogen substituent is alkyl as previously described.

The term “aryl” refers to a univalent group formed by removing a hydrogen atom from a ring carbon in an arene, including mono- or polycyclic aromatic hydrocarbons, and may include heteroatoms. Multiple ring aryls may be fused together, linked covalently, or linked to a common group such as an ethylene, methylene or oxy moiety. The aromatic rings of the aryl group may each and optionally contain heteroatoms. The aryl group can be optionally substituted with one or more aryl group substituents which can be the same or different, where “aryl group substituent” includes alkyl, aryl, arylalkyl, hydroxy, alkoxyl, aryloxy, arylalkoxyl, carboxy, acyl, halo, alkoxycarbonyl, aryloxycarbonyl, arylalkoxycarbonyl, acyloxyl, alkylene. An aryl may be represented herein with the symbol Ar— and an arene may be represented by ArH.

As used herein, the terms “substituted alkyl” and “substituted aryl” include alkyl and aryl groups, as defined herein, in which one or more atoms or functional groups of the aryl or alkyl group are replaced with another atom or functional group, including for example, halogen, aryl, alkyl, alkoxyl, hydroxyl, nitro, amino, alkylamino, dialkylamino, sulfate, and mercapto.

As used herein, the term “arylene” shall denote a divalent group formed by removing two hydrogen atoms from a ring carbon in an arene (i.e., a mono- or polycyclic aromatic hydrocarbon), and may include heteroatoms.

The term “heteroatom” used in conjunction with a borane (boron hydride cluster) means any atom other than boron and hydrogen and used in conjunction with a hydrocarbon means any atom other than carbon and hydrogen such as nitrogen, oxygen, sulfur, phosphorus, chlorine, bromine, or iodine.

As used herein, the term “halogen” refers to chlorine, bromine, fluorine, or iodide.

The term “carboxy,” as used herein, means a group of formula —COOH.

The term “hydroxy,” as used herein, means a group of formula —OH.

### Polyarylboranes

General Description

As set forth above, an embodiment of the invention is a polyarylborane comprising a substituted polyhedral borane comprising at least 3 exohedrally bonded aryl groups, wherein the substituted polyhedral borane is homo- or hetero-, and each exohedrally bonded aryl group is independently homo- or hetero-, substituted or unsubstituted, and monocyclic or polycyclic.

Various permutations of the foregoing are further embodiments of the invention. For example, the substitute polyarylborane may be hetero- and comprise one or more heteroatoms (i.e., the core of the substituted polyhedral borane comprises a core that comprises one or more deltahedral cages that comprise cage atoms, wherein one or more of the cage atoms are heteroatoms in comparison to boron atoms). If there are multiple such heteroatoms, they could be the same or they could be independently selected from a group of heteroatoms.

The exohedrally bonded aryl groups allow for even more permutations than the polyhedral borane to which they are bonded. For example, many or all of such exohedrally bonded aryl groups may be of different combinations homo- or hetero-, substituted or unsubstituted, and monocyclic or polycyclic. At the other end of the permutation spectrum all of the exohedrally bonded aryl groups may be of the same combination of homo- or hetero-, substituted or unsubstituted, and monocyclic or polycyclic. Other exemplary embodiments include: all the exohedrally bonded aryl groups are hetero- with the same heteroatom; all the exohedrally bonded aryl groups are substituted with the same substituent; all the exohedrally bonded aryl groups are polycyclic with the same number of rings; and combinations of the foregoing.

Polyhedral Structures

As indicated above, the substituted polyhedral borane comprises a core that comprises one or more deltahedral cages, wherein each deltahedral cage comprises cage atoms, wherein each cage atom defines a vertex of at least one of the deltahedral cages and the core. Each deltahedral cage has a number of vertices independently selected from the group consisting of 4, 5, 6, 7, 8, 9, 10, 11, and 12. Further, because the structure is generally that of a polyhedral borane, at least a majority of the cage atoms of each deltahedral cage are boron. In various embodiments, all the cage atoms of at least one of the deltahedral cages are boron. In various embodiments, all the cage atoms of all the deltahedral cages are boron. Still further embodiments include those in which the number of cage atoms and vertices per deltahedral cage is 10 or 12.

In various embodiments, the core comprises of one deltahedral cage.

In various embodiments, the core comprises more than one deltahedral cage (e.g., two deltahedral cages). For embodiments that comprises more than one deltahedral cage (e.g., the deltahedral cages are associated in some manner such as being fused, tethered, ligands of a metal complex, or a combination thereof), the number of cage atoms for the core corresponds to the sum of the number of cage atoms of each deltahedral cage taking care not to count any cage atoms that are shared between deltahedral cages (e.g., when deltahedral cages are fused) more than once. Exemplary embodiments include wherein the number of cage atoms for the core is in the range of from 14 to 40 cage atoms, 18 to 30 cage atoms, and 22 to 26 cage atoms. In one or more embodiments, a tethered cage compound has 24 cage atoms.

In addition to controlling the number of cage atoms and vertices, the shape or structure of the deltahedral cage(s) and core may depend on whether the polyhedrons are missing one or more vertices. In various embodiments, the core may comprise one or more deltahedral cages having a closed or closo-polyhedral structure (i.e., polyhedrons missing no vertices; e.g., closo-, hypercloso-). Examples of polyhedral shapes suitable for the deltahedral cage(s) include trigonal bipyramid, octahedron, pentagonal bipyramid, dodecahedron, tricapped trigonal prism, bicapped square antiprism, octadecahedron, and icosahedron. Additionally, in various embodiments, the core may comprise one or more deltahedral cages having a polyhedral structure missing one or more vertices (i.e., nido-, arachna-, and hypho-).

Additionally, as indicated above, it is possible for the core to comprise two or more deltahedral cages and in some embodiments the deltahedral cages may be based on the same polyhedral shape or different polyhedral shapes, and/or may have polyhedral structures that are closed or missing one or more vertices. In various embodiments, the deltahedral cages are based on the same polyhedral shape (e.g., icosahedron) and have polyhedral structures that are the same (e.g., closo- or nido-). In various embodiments, each deltahedral cage has a bicapped square antiprism structure. In various embodiments, each cage has an icosahedron structure. In various embodiments, the core has a closo-polyhedral structure. In certain of such closo-polyhedral structure embodiments, the core comprises one deltahedral cage that has an icosahedral structure or bicapped square antiprism structure.

In various embodiments, each deltahedral cage has a general structure corresponding to that of a polyhedral borane selected from the group consisting of formula selected from the group consisting of BₙHₙ (hypercloso-), [BₙHₙ]²⁻ (closo-), BₙHₙ₊₄ (nido-), BₙHₙ₊₆ (arachno-), BₙHₙ₊₈ (hypho-), wherein n=4, 5, 6, 7, 8, 9, 10, 11, or 12.

In various embodiments, each deltahedral cage has a general structure corresponding to that of a polyhedral borane selected from the group consisting of formula selected from the group consisting of BₙHₙ (hypercloso-), [BₙHₙ]²⁻ (closo-), BₙHₙ₊₄ (nido-), BₙHₙ₊₆ (arachno-), BₙHₙ₊₈ (hypho-), wherein n=10.

In various embodiments, each deltahedral cage has a general structure corresponding to that of a polyhedral borane selected from the group consisting of formula selected from the group consisting of BₙHₙ (hypercloso-), [BₙHₙ]²⁻ (closo-), BₙHₙ₊₄ (nido-), BₙHₙ₊₆ (arachno-), BₙHₙ₊₈ (hypho-), wherein n=12.

In various embodiments, core comprises one deltahedral cage and the deltahedral cage has a general structure corresponding to that of a polyhedral borane selected from the group consisting of formula selected from the group consisting of BₙHₙ (hypercloso-), [BₙHₙ]²⁻ (closo-), BₙHₙ+₄ (nido-), BₙHₙ+₆ (arachno-), BₙHₙ₊₈ (hypho-), wherein n=10 or 12.

In various embodiments, the polyhedral borane that is subjected to the arene substitutions disclosed herein, whether pre-substituted or unsubstituted and homo- or hetero, is selected from the group consisting of closo-dodecahydrododecaborate ([B₁₂H₁₂]²⁻); closo-dodecahydrododecaborate ([B₁₀H₁₀]²⁻); o-, m-, and p-dicarbadecahydrododecaboranes; carboranes ([C₂B₁₀H₁₂]); and nido-decaborane ([B₁₀H₁₄]).

Multiple Deltahedral Cages

As indicated above, the core may comprise more than one deltahedral cage n such embodiments, the deltahedral cages are associated in some manner such as being fused, tethered, ligands of a metal complex, or a combination thereof.

Fused Deltahedral Cages

The core may have one or more of such polyhedral shapes fused together (i.e., a conjuncto-configuration). In various embodiments, the core comprises more than one deltahedral cage wherein at least two deltahedral cages are associated by being fused (i.e., the cages are conjuncto-).

Tethered Deltahedral Cages

Further, the core may have a tethered-configuration in which two or more of such structures tethered together by a multivalent linking group capable of linking two or more deltahedral cages together. In various embodiments, the core comprises more than one deltahedral cage wherein at least two deltahedral cages are associated by being tethered or in a tethered configuration in which two or more deltahedral cages are tethered together by a linking group.

In various embodiments the linking group is an alkylene group or an arylene group. In various embodiments, the alkylene linking group or arylene linking group is unsubstituted. In various embodiments, the alkylene linking group or arylene linking group is substituted. In various embodiments, the linking group is a substituted or unsubstituted C₁ to C₂₀ alkylene. In various embodiments, the alkylene linking group is straight, branched, or cyclic, and saturated or unsaturated. In various embodiments, the alkylene linking group is a straight-chain C₁ to C₁₂ alkylene group.

In various embodiments, the linking group is an arylene group selected from the group consisting of 1,2-ethylene, 1,3-n-propylene, and 1,4-n-butylene.

In various embodiments, the linking alkylene or arylene group is heteroatom-substituted having more than two free valencies.

Metal Complexes

Still further, as indicated, the core may have the deltahedral cages that are associated in the manner of ligands of a metal complex. These configurations are often referred to as metalloboranes or metallocarboranes. In certain embodiments two clusters are bridged by a metal atom. Suitable metals include any metal capable of forming an air and moisture stable complex such as metals from Group 3, 4, 5, 6, 7, 8, 9, 10, 11, 12 of the Periodic Table, lanthanides selected from Elements 57-71 of the Periodic Table (which along with Sc and Y may be collectively referred to as rare earth elements), and actinides selected from Elements 89-103 of the Periodic Table. In various embodiments the metal atom is selected from the group consisting of iron, molybdenum, nickel, zinc, chromium, cobalt, titanium, zirconium, and hafnium.

For information regarding metallocarboranes and metalloboranes, incorporated herein by reference is Callahan et al., New Chemistry of Metallocarboranes and Metalloboranes, Department of Chemistry, University of California, Los Angeles, Calif. 90024, USA, p. 475-495.

Hetero-Cage Atoms

In other various embodiments one or more, but not all, of the boron cage atoms may be replaced with an atom other than boron or hydrogen such as carbon, silicon, germanium tin, nitrogen, phosphorus, arsenic, sulfur, and selenium. These are commonly referred to as “heteroboranes.” Heteroboranes, like the related boranes, are polyhedral and are similarly classified as classified as closo-, nido-, arachno-, hypho-, etc. based on whether they represent a complete (closo-) polyhedron, or a polyhedron that is missing one (nido-), two (arachno-), or more vertices. In various embodiments, the number of hetero-cage atoms per deltahedral cage is no more than one-quarter of the number of vertices of the deltahedral cage.

Of particular interest is carbon atoms, with the resulting compounds being commonly referred to as “carboranes” as indicated above. Thus, in various embodiments, the cage compound can comprise boron atoms or a combination of boron and carbon atoms as cage atoms. In various embodiments, at least about 50 percent, at least about 60 percent, at least about 70 percent, at least about 80 percent, or at least 90 percent of the cage atoms of each hetero-deltahedral cage is boron atoms. In various embodiments, each hetero-deltahedral cage comprises in the range of from 1 to 6 carbon cage atoms, in the range of from 1 to 4 carbon cage atoms, or in the range of from 1 to 2 carbon cage atoms. In embodiments, each hetero-deltahedral cage comprises two carbon cage atoms.

Exohedrally Bonded (Pendant) Aryl Groups

As indicated above, the substituted polyhedral borane comprises at least 3 exohedrally bonded aryl groups, wherein the substituted polyhedral borane is homo- or hetero-, and each exohedrally bonded aryl group is independently homo- or hetero-, substituted or unsubstituted, and monocyclic or polycyclic.

This allows for many permutations such immediately following examples. In various embodiments, the exohedrally bonded aryl groups may be independently selected from an unsubstituted aryl group or a substituted aryl group. In various embodiments, the exohedrally bonded aryl groups are independently selected from unsubstituted aryl groups. In various embodiments, the exohedrally bonded aryl groups are independently selected from substituted aryl groups. In various embodiments, the exohedrally bonded aryl groups are the same unsubstituted aryl group. In various embodiments, the exohedrally bonded aryl groups are the same substituted aryl group. In various embodiments, the exohedrally bonded aryl groups are the same particular aryl group, but both substituted with the same substitution and unsubstituted versions are present. Further, the various exemplary embodiments with different combinations of substituted and unsubstituted aryl groups, may be further varied by selected whether one or more of the aryl groups is homo- or hetero- and/or monocyclic or polycyclic.

In various embodiments, each exohedrally bonded aryl group that is substituted comprises a substituent that is independently selected from the group consisting of alkyl, aryl, arylalkyl, hydroxy, alkoxyl, aryloxy, arylalkoxyl, carboxy, acyl, halo, alkoxycarbonyl, aryloxycarbonyl, arylalkoxycarbonyl, acyloxyl, alkylene, alkylsulfide, alkylamino, thiol.

In various embodiments, the exohedrally bonded aryl groups are from arenes independently selected from the group consisting of benzene, chlorobenzene, 1,2-dichlorobenzene, 1,3-dichlorobenzene, 1,4-dichlorobenzene, bromobenzene, 1,2-dibromobenzene, 1,3-dibromobenzene, iodobenzene, fluorobenzene, toluene, xylene, phenol, styrene, naphthalene, chloronaphthalene, bromonaphthalene, iodonaphthalene, biphenyl, fluorene, triphenylene, phenanthrene, anthracene, and pyrene.

In various embodiments, each exohedrally bonded aryl group that is hetero-comprises a heteroatom selected from the group consisting of N, S, and O.

As indicated above, the substituted polyhedral borane comprises at least 3 exohedrally bonded aryl groups. In various embodiments, the maximum number of exohedrally bonded aryl groups per deltahedral cage is equal to the number of vertices of the deltahedral cage. In various embodiments, the maximum number of exohedrally bonded aryl groups per deltahedral cage is less than the number of vertices of the deltahedral cage. In various embodiments, the maximum number of exohedrally bonded aryl groups per deltahedral cage is about two-thirds the number of vertices of the deltahedral cage. In various embodiments, the maximum number of exohedrally bonded pendant aryl groups corresponds that the number allowed by stearic hindrance (addressed in more detail below).

### Exohedrally Bonded Non-Aryl Substituents (Pendant Atoms and Groups)

In various embodiments, the substituted polyhedral borane may comprise one or more pendant atoms or pendant groups (i.e., exohedrally bonded non-aryl substituents). As used with respect to polyhedral boranes, generally, herein, the term “pendant” shall be construed as meaning covalently bound to the core, generally, and to a cage atom, in particular. Typically, such exohedrally bonded non-aryl substituents are present on the polyhedral borane reagent before the arene substitution described herein is performed. Although atypical, it should be noted that it is possible for the polyhedral borane reagent to comprise up to two aryl substituents before conducting the arene substitution process described herein. That said, any such pre-existing aryl substituents are exohedrally bonded aryl groups.

In various embodiments, the exohedrally bonded non-aryl substituents may covalently bound to one or more cage atoms. Examples of atoms suitable for use as pendant atoms include, but are not limited to, single valence atoms, such as chlorine, bromine, or iodine.

In various embodiments, at least one of the exohedrally bonded non-aryl substituents is covalently bonded to a boron cage atoms and said bond is independently selected from the group consisting of a boron-halogen bond, boron-carbon bond, boron-nitrogen bond, boron-phosphorus bond, boron-arsenic bond, boron-sulfur bond, and boron-selenium bond.

In various embodiments, the exohedrally bonded non-aryl substituents may be pendant groups or functional groups that may be generally reactive (e.g., carboxyl groups) or generally non-reactive (e.g., unsubstituted, saturated alkyl groups).

In various embodiments, the exohedrally bonded non-aryl substituents are independently selected from the group consisting of carboxyls, alkyls (e.g., methyl, ethyl, etc.), alkenyls (e.g., vinyl, allyl, etc.), alkynyls, alkoxys, epoxys, hydroxys, acyls, carbonyls, aldehydes, carbonate esters, carboxylates, ethers, esters, hydroperoxides, peroxides, carboxamides, amines, imines, imides, azides, azos, cyanates, isocyanates, nitrates, nitriles, nitrites, nitros, nitrosos, pyridyls, phosphinos, phosphates, phosphonos, sulfos, sulfonyls, sulfinyls, sulfhydryls, thiocyanates, disulfides, silyls, and alkoxy silyls (e.g., triethoxysilyl).

In various embodiments, the exohedrally bonded non-aryl substituents are independently selected from the group consisting of C₁ to C₂₀ n-alkyl, a C₁ to C₁₂ n-alkyl, a C₁ to C₈ n-alkyl, a hydroxy, a carboxy, an epoxy, an isocyanate, a cyanurate, a primary amine, a silyl, and an alkoxy silyl.

### Applications

The above-described polyarylboranes may be used and incorporated into materials and devices for a wide variety of applications. In various embodiments, such a polyarylborane is part of a molecule (e.g., a polyarylborane salt). In various embodiments, the invention is directed to a composition, a polymer, a photocatalyst, an electroluminescent material, a polymerizable monomer, a non-linear optical material, or a molecular electronic material comprising such a polyarylborane or a molecule comprising said polyarylborane.

### Synthesis of Polyarylboranes

In various embodiments of the present invention, polyarylboranes may be made, produced or synthesized by a method or process comprising: heating a reaction mixture that comprises a liquid phase solvent and a solute polyhedral borane in the solvent, wherein the solvent comprises one or more arenes, to react at least one of the polyhedral boranes and at least one of the arenes for a duration sufficient to form the substituted polyhedral borane comprising at least 3 exohedrally bonded aryl groups, wherein the polyhedral borane is homo- or hetero-, and the arene is homo- or hetero-, substituted or unsubstituted, and monocyclic or polycyclic.

Reagents

Polyhedral Borane

Several different salts of dodecaborate have been successfully employed in these reactions, including those containing quaternary ammonium or phosphonium cations. In every example, the scale of the reaction is only limited by the solubility of the salt in the chosen solvent/arene reagent; for quaternary ammonium salts, such as the bis-tetrabutylammonium salt, reaction concentrations of between 1-10 mg/ml are useful.

Exemplary polyhedral boranes may be homo- or hetero- as described above, and may comprise one or more exohedrally bonded non-aryl substituents, and even may comprise up to two exohedrally aryl groups that may be homo- or hetero-, substituted or unsubstituted, and monocyclic or polycyclic as suggested and described above. In fact, it is contemplated that essentially all of the description regarding the core of the substituted polyhedral borane applies equally to the polyhedral borane that is subjected to the method described herein.

In various embodiments, the polyhedral borane is selected from the group consisting of closo-dodecahydrododecaborate ([B₁₂H₁₂]²⁻); closo-dodecahydrododecaborate ([B₁₀H₁₀]²⁻); o-, m-, and p-dicarbdecahydrododecaboranes; carboranes (C₂B₁₀H₁₂); nido-decaborane (B₁₀H₁₄); and combinations thereof.

For information regarding closo-dodechydrododecaborate anion [B₁₂H₁₂]²⁻, including its manufacture, incorporated herein by reference is Sivaev et al., Chemistry of closo-Dodecaborate Anion [B₁₂H₁₂]²⁻: A Review, Collect. Czech. Chem. Commun., Vol. 67 (2002), 679-727.

In one or more embodiments of the present invention, the polyhedral borane may comprise a closo-carborane having the general formula [C₂BₙHₙ₊₂], wherein n can be in the range of from 5 to 10. Additionally, in various embodiments, the polyhedral borane may comprise a closo-carborane having the general formula C₂BₙHₙ₊₂, wherein n is 10 (i.e., closo-dicarbadodecaborane). When the polyhedral borane is a closo-dicarbadodecaborane, it may be in the ortho- (i.e., 1,2-closo-dicarbadodecaborane), meta- (i.e., 1,7-closo-dicarbadodecaborane), or para- (i.e., 1,12-closo-dicarbadodecaborane) configuration. In one embodiment, the polyhedral borane may be a 1,2-closo-dicarbadodecaborane. Additionally, such closo-carboranes may include any one or more of the pendant groups described above. For example, in various embodiments of the present invention, the polyhedral borane may comprise a closo-carborane having the general formula [C₂BₙHₙ₊₂₋ₓRₓ], wherein n may in the range of from 5 to 10, x may be in the range of from 1 to 2, and wherein each R may be the same or different, and may independently comprise any of the pendant groups mentioned above. For instance, R may be selected from aliphatic compounds (e.g., n-hexyl) and/or heteroatom-containing aliphatic compounds.

In one or more embodiments of the present invention, the polyhedral borane may comprise a closo-carborane salt or the having the general formula X[CBₙHₙ₊₁], where n may be in the range of from 6 to 11, and X may be any of a variety of cationic species allow for the salt to be soluble in the reagent solvent. Additionally, such closo-carborane salts can include any one or more of the pendant groups described above. For example, in various embodiments of the present invention, the cage compound employed can comprise a closo-carborane salt having the general formula X[CBₙHₙ R], where n may be in the range of from 6 to 11, X may be any of a variety of cationic species allow for the salt to be soluble in the reagent solvent, and where R can be any of the pendant groups mentioned above. For instance, R can be chosen from aliphatic compounds (e.g., n-hexyl) and/or heteroatom-containing aliphatic compounds.

In various embodiments of the present invention, the polyhedral borane may comprise a closo-borane salt having the general formula X₂[BₙHₙ], where n may be in the range of from 7 to 12, and X may be any of a variety of cationic species allow for the salt to be soluble in the reagent solvent. Additionally, in various embodiments, the polyhedral borane may comprise a closo-borane having the general formula X₂[BₙHₙ], where n is 12 (i.e., a dodecaborate), and X may be any of a variety of cationic species allow for the salt to be soluble in the reagent solvent. Furthermore, such closo-boranes may include any one or more of the pendant groups described above.

In various embodiments of the present invention, the polyhedral borane may comprise a closo-borane salt having the general formula X₂[BₙHₘ(OR)ₚ], wherein each R may individually be hydrogen atoms and/or or aliphatic groups (e.g., a methyl or ethyl group), wherein n may be in the range of from 7 to 12, wherein m+p=n, with p being in the range of from 1 to 12, or in the range of from 2 to 12, and X may be any of a variety of cationic species allow for the salt to be soluble in the reagent solvent. Furthermore, such closo-boranes may include any one or more of the pendant groups described above.

In various embodiments of the present invention, the polyhedral borane may comprise a nido-carborane salt having the general formula X₂[C₂BₙHₙ₊₂₋ₓRₓ] wherein x is in the range of from 1 to 2, n is in the range of from 5 to 9, and each R may be the same or different, and may independently comprise any of the pendant groups mentioned above. For instance, R can be chosen from aliphatic compounds (e.g., n-hexyl) and/or heteroatom-containing aliphatic compounds. X may be any of a variety of cationic species allow for the salt to be soluble in the reagent solvent. In one or more embodiments, n is 9, giving the general formula X₂[C₂B₉H₁₁₋ₓRₓ], wherein x is in the range of from 1 to 2, and each R may be the same or different, and may independently comprise any of the pendant groups mentioned above, and where X may be any of a variety of cationic species allow for the salt to be soluble in the reagent solvent.

In various embodiments of the present invention, the polyhedral borane may comprise a nido-carborane salt having the general formula X₃[CBₙHₙ₊₁₋ₓRₓ], wherein x is in the range of from 0 to 1, n is in the range of from 6 to 10, and R may comprise any of the pendant groups mentioned above. For instance, R can be chosen from aliphatic compounds (e.g., n-hexyl) and/or heteroatom-containing aliphatic compounds. X may be any of a variety of cationic species allow for the salt to be soluble in the reagent solvent. In one or more embodiments, n is 10, giving the general formula X₃[CB₁₀H₁₁₋ₓRₓ], wherein x is in the range of from 0 to 1, R may comprise any of the pendant groups mentioned above, and X may be any of a variety of cationic species allow for the salt to be soluble in the reagent solvent.

Solvent and Arenes

Examples of the arenes (or arene reagents or aromatic reagents) may be selected from that is appropriate and for reacting with the polyhedral borane reagent. The solvent may comprise more than one arene. In various embodiments, the solvent consists of one or more arenes (i.e., the arene is the solvent). Stated another way, the reactions producing the polyarylboranes may be carried out neat, using the desired aromatic species as both a reagent and the reaction solvent. For reagents having melting points above ambient temperatures, reactions may be carried out in the melts.

In various embodiments, the one or more arenes is/are selected from the group consisting of benzene, chlorobenzene, 1,2-dichlorobenzene, 1,3-dichlorobenzene, 1,4-dichlorobenzene, bromobenzene, 1,2-dibromobenzene, 1,3-dibromobenzene, iodobenzene, fluorobenzene, toluene, xylene, phenol, styrene, naphthalene, chloronaphthalene, bromonaphthalene, iodonaphthalene, biphenyl, fluorene, triphenylene, phenanthrene, anthracene, pyrene, and combinations thereof.

Temperature and Duration and Pressure

Reaction temperatures ranging between 150-220° C. have been successfully employed. As these temperatures are well above the normal boiling points of many of the reagents investigated, many such reactions may be conducted under autogenous pressures in sealed vessels designed for such pressurized reactions. These included glass microwave reaction vials, heavy-walled glass pressure bottles, and Teflon lined autoclave reaction vessels.

Before carrying out such syntheses, carefully inspect reaction vessels, employ adequate shielding and proper cautionary signage, as well as to understand the temperature/pressure characteristics for the reagents to be used. Using such precautions, the inventor(s) have carried out more than 300 such reactions without incident.

### Separation of Product and Arene Reagent

Upon completion, excess reagent may be removed in vacuo. To remove reagents having low vapor pressure, a high vacuum line equipped with an oil diffusion pump is useful.

### Purification of Product

The crude products may be further purified using silica gel chromatography and the pure product eluted with a dichloromethane/acetonitrile mixture.

### Examples

Various reaction conditions and product compositions were explored using dodecaborate and several aromatic reagents. Table 1, below, provide the details of the reactions conditions, including concentration, time, and temperature, for several reagents, as well as the average degree of substitution for the isolated products. The precise mass/charge (m/z) ratio for the most abundant product peak is listed, along with the theoretically computed vale.

TABLE 1

| | | | | Product | | |
|---|---|---|---|---|---|---|
| | Concentration | Temp. | Time | Average | m/z | |
| Reagent | (mg B12 salt/g reagent) | (° C.) | (hrs) | Substitution | found | m/z calc. |
| biphenyl | 15 mg/5 g | 160 | 7 | 6 | 527.7995 | 527.7946 |
| | 100 mg/20 g | 160 | 8 | 4 | 375.2337 | 375.2324 |
| | 100 mg/20 g | 160 | 16 | 5 | 451.7839 | 451.7881 |
| | 25 mg/20 g | 165 | 7 | 8 | 679.8557 | 679.8579 |
| fluorene | 25 mg/10 g | 180 | 32 | 6 | 563.7835 | 563.7948 |
| | 100 mg/10 g | 180 | 32 | 6 | 563.7889 | 563.7948 |
| naphthalene | 100 mg/20 g | 180 | 3 | 6 | 449.8194 | 449.7724 |
| | 25 mg/20 g | 180 | 1 | 5 | | |
| benzene | 7 mg/5 g | 165 | 48 | 8 | 375.1930 | 375.2324 |
| | 200 mg/200 g | 150 | 40 | 7 | 337.2210 | 337.2166 |
| | 5 mg/5 g | 180 | 2 | 5 | | |
| toluene | 5 mg/5 g | 180 | 2 | 5 | 296.2347 | 296.2243 |
| | 5 mg/5 g | 190 | 3.5 | 6 | 341.2771 | 341.2686 |
| | 5 mg/5 g | 160 | 4 | 5 | 296.2389 | 296.2243 |
| | 7 mg/5 g | 165 | 48 | 7 | 386.7897 | 386.7959 |
| phenol | 10 mg/5 g | 220 | 2 | 4 | 255.1488 | 255.1590 |
| pyrene | 120 mg/5 g | 180 | 2 | 2 | 271.6776 | 271.6942 |
| | 5 mg/5 g | 160 | 26 | 3 | 371.1841 | 371.2011 |
| | 7 mg/2 g | 215 | 2 | 6 | 671.8002 | 671.7953 |
| triphenylene | 7 mg/5 g | 215 | 2 | 5 | 749.8324 | 749.8425 |
| anthracene | 7 mg/5 g | 215 | 2 | 7 | 688.3445 | 688.3507 |
| phenanthrene | 7 mg/5 g | 215 | 2 | 6 | 599.7898 | 599.7950 |
| chlorobenzene | 5 mg/6 g | 150 | 36 | 7 | 458.0982 | 458.1047 |
| | 25 mg/60 g | 180 | 6 | 8 | 513.1558 | 513.0738 |
| bromobenzene | 5 mg/5 g | 220 | 2 | 7 | 613.9188 | 613.9279 |
| | 5 mg/5 g | 200 | 8 | 8 | 691.3778 | 691.3988 |

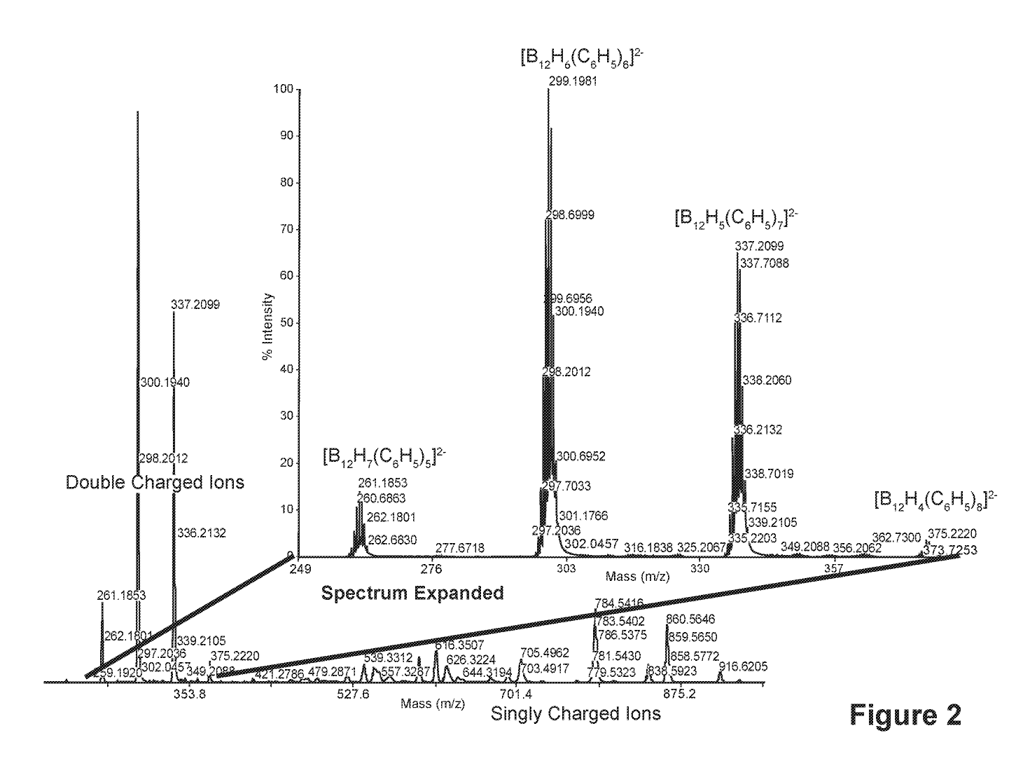

The analysis of the reaction products is ideally accomplished using high resolution, high mass accuracy mass spectrometry. A time of flight mass analyzer operated under negative ion mode and equipped with electrospray ionization was used for this purpose. As each product is ionic, their relative abundances are directly observed as both doubly-charged ions, as well as singly-charged adducts that carry one organic cation from the ionic starting material. In these analyses, the precise mass of each product matches that predicted, given the loss of two hydrogen atoms, (one from the arene and one from B12) for each substitution that occurs. FIG. 2 depicts a typical mass spectrum obtained from a reaction between benzene and B12, resulting in an average of 6.4-fold substitution (the major products have 6 and 7 benzyl substitutions).

In compliment with mass spectrometry, boron-11, carbon-13, and hydrogen-1 NMR also provides useful information regarding product structure and composition.

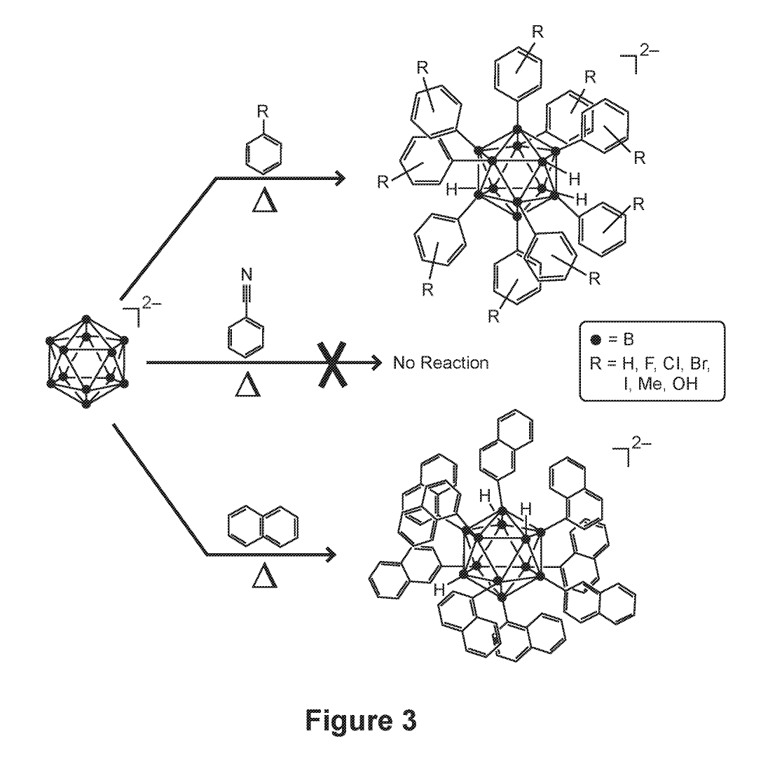

With several deviations and without being bound to a particular theory, these reactions appear to follow electrophilic aromatic substitution (EAS). For example, the presence of a weak deactivating group on benzene, such as chlorine, appears to decrease the reaction rate, while the presence of an activating group, such as with toluene increases reaction rate. The presence of a strongly deactivating group, such as nitrile of benzonitrile, prevents reaction completely, even after employing higher temperatures and prolonged reaction times. See FIG. 3, middle depiction. Also consistent with an EAS mechanism, the rates of reaction between dodecaborate with polycyclic aromatic hydrocarbons appear to be higher than that with benzene. In the reaction with biphenyl, the expected para-substituted product was observed. Reaction conditions were optimized such that the singly-substituted product could be isolated and characterized, confirming the structure of this product. However, in an observation which is inconsistent with the EAS mechanism, the singly-substituted naphthalene derivative is substituted on carbon 2 or naphthalene, whereas carbon 1 would be the expected product.

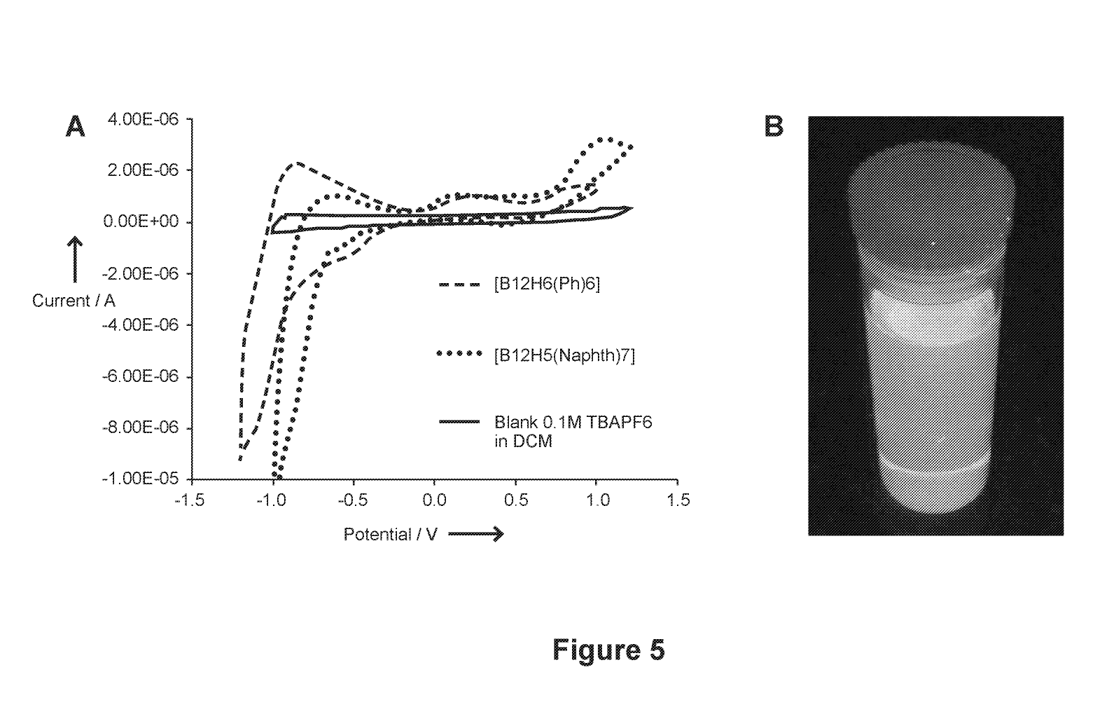

Many of these reaction products described are highly photoluminescent in a variety of organic solvents. For example, FIG. 5 B is a picture of the visible fluorescence emission of [B₁₂H₅(C₁₀H₇)₇]²⁻ in dichloromethane. The fluorescence quantum yields for several of these products are much higher than those of their individual aromatic substituents and have been measured using the comparative method against two separate well characterized standards having well known quantum yields; para-terphenyl and 9,10-diphenylanthracene. Table 2 lists the measured fluorescence quantum yield for the standards and several new polyarylboranes.

TABLE 2

| Compound | Fluorescence Quantum Yield Φ |
|---|---|
| para-terphenyl | 0.92 (literature value) |
| 9,10-diphenylanthracene | 0.95 (literature value) |
| [B₁₂H₅(C₁₂H₉)₇] (biphenyl-7) | 0.72 |
| [B₁₂H₁₁(C₁₂H₉)₁] (biphenyl-1) | 0.49 |
| [B₁₂H₅(C₁₀H₇)₇] (naphthalene-7) | 0.52 |
| [B₁₂H₁₁(C₁₀H₇)₁] (naphthalene-1) | 0.46 |
| [B₁₂H₅(C₁₃H₉)₇] (fluorene-7) | 0.58 |

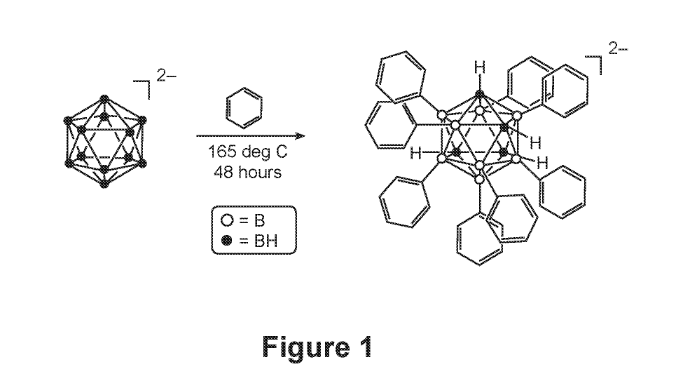

Many species were prepared through a direct reaction between an arene, or substituted arene with organic salts of B12 such as depicted in FIG. 1. In particular, FIG. 1 depicts a reaction between dodecahydrododecaborate and benzene, producing a product having an average of eight phenyl substituents. Surprisingly, under optimal conditions, these reactions are clean and are observed to be virtually quantitative with the reactants.

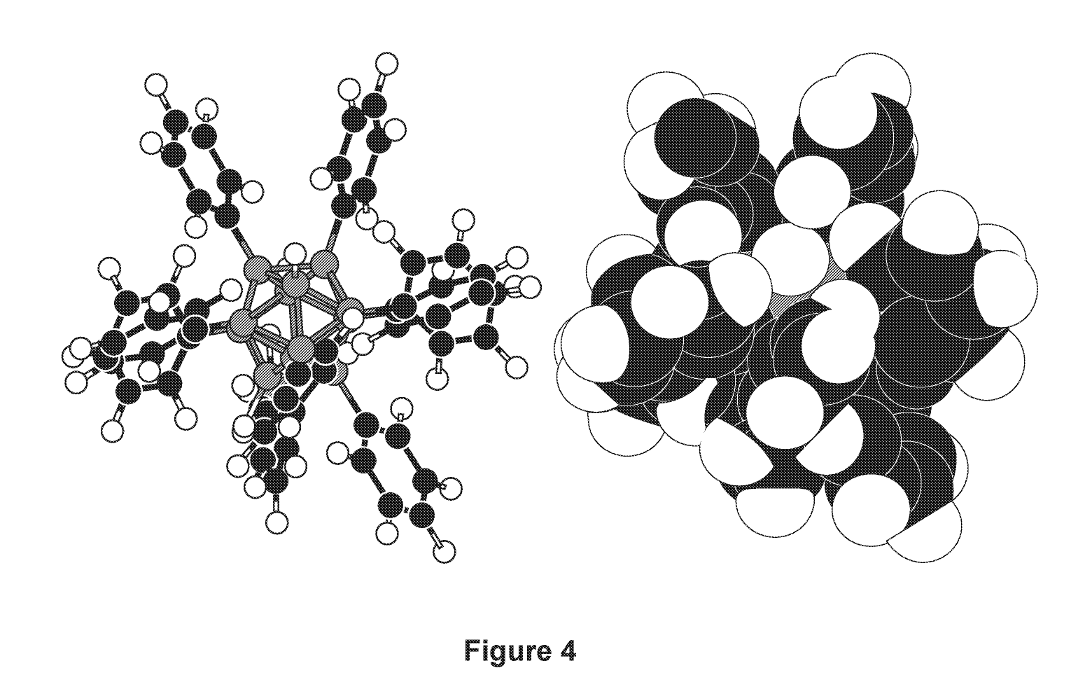

The elucidation of the acceptable and optimal reaction conditions required running several hundred reactions. This was owed, in part, to a desire to obtain 12-fold substituted clusters. Given that the exhaustive efforts thus far to accomplish this were unsuccessful, it is presently believed that persubstitution of the cage with arenes most likely cannot be achieved. Regardless of the arene used and the times/temperatures employed, 9-fold substitution appears was the maximal degree of substitution achieved. FIG. 4 depicts both a ball and stick and space filling model for an isomer of the 9-fold benzene cluster in the same orientation. In the space filling model, it is apparent that each of the three remaining hydrogen atoms on the B12 cage are crowded by surrounding phenyl groups and it is likely that steric hindrance will prevent further cage substitution.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

What is claimed is:

1. A polyarylborane comprising a substituted polyhedral borane comprising at least 3 exohedrally bonded aryl groups, wherein the substituted polyhedral borane is homo- or hetero-, and each exohedrally bonded aryl group is independently homo- or hetero-, substituted or unsubstituted, and monocyclic or polycyclic.

2. The polyarylborane of claim 1, wherein the substituted polyhedral borane comprises a core that comprises one or more deltahedral cages, wherein each deltahedral cage comprises cage atoms, wherein each cage atom defines a vertex of at least one of the deltahedral cages and the core, wherein each deltahedral cage has a number of vertices independently selected from the group consisting of 4, 5, 6, 7, 8, 9, 10, 11, and 12, and wherein at least a majority of the cage atoms of each deltahedral cage are boron.

3. The polyarylborane of claim 2, wherein all the cage atoms of at least one of the deltahedral cages are boron.

4. The polyarylborane of claim 2, wherein all the cage atoms of all the deltahedral cages are boron.

5. The polyarylborane of claim 2, wherein at least one cage atom of at least one deltahedral cage is a heteroatom independently selected from the group consisting of carbon, silicon, germanium tin, nitrogen, phosphorus, arsenic, sulfur, and selenium.

6. The polyarylborane of claim 5, wherein the number of hetero-cage atoms per deltahedral cage is no more than one-quarter of the number of vertices of the deltahedral cage.

7. The polyarylborane of claim 2, wherein each deltahedral cage has 10 or 12 vertices.

8. The polyarylborane of claim 2, wherein the core comprises two or more deltahedral cages that are fused.

9. The polyarylborane of claim 2, wherein the core comprises two or more deltahedral cages that are tethered by a multivalent linking group capable of linking the two or more deltahedral cages together, wherein the linking group is a substituted or unsubstituted C₁ to C₂₀ alkylene or arylene group.

10. The polyarylborane of claim 2, wherein the core comprises two or more deltahedral cages that are ligands of a metal complex, wherein the ligands are bridged by a metal atom.

11. The polyarylborane of claim 2, wherein each deltahedral cage has a general structure corresponding to that of a polyhedral borane selected from the group consisting of formula selected from the group consisting of BₙHₙ (hypercloso-), [BₙHₙ]²⁻ (closo-), BₙHₙ₊₄ (nido-), BₙHₙ₊₆ (arachno-), BₙHₙ₊₈ (hypho-), wherein n=4, 5, 6, 7, 8, 9, 10, 11, or 12.

12. The polyarylborane of claim 11, wherein n is 10 or 12.

13. The polyarylborane of claim 2, wherein each deltahedral cage has a general structure corresponding to that of a polyhedral borane selected from the group consisting of closo-dodecahydrododecaborate ([B₁₂H₁₂]²⁻), closo-dodecahydrododecaborate ([B₁₀H₁₀]²⁻), o- and m- and p-dicarbadecahydrododecaboranes, carboranes ([C₂B₁₀H₁₂]), and nido-decaborane ([B₁₀H₁₄]).

14. The polyarylborane of claim 1, wherein the exohedrally bonded aryl groups are independently selected from an unsubstituted aryl group or a substituted aryl group,
wherein each exohedrally bonded aryl group that is substituted comprises a substituent that is independently selected from the group consisting of alkyl, aryl, arylalkyl, hydroxy, alkoxyl, aryloxy, arylalkoxyl, carboxy, acyl, halo, alkoxycarbonyl, aryloxycarbonyl, arylalkoxycarbonyl, acyloxyl, alkylene, alkylsulfide, alkylamino, thiol, and
wherein each exohedrally bonded aryl group that is hetero- comprises a heteroatom selected from the group consisting of N, S, and O.

15. The polyarylborane of claim 1, wherein the exohedrally bonded aryl groups are arenes independently selected from the group consisting of benzene, chlorobenzene, 1,2-dichlorobenzene, 1,3-dichlorobenzene, 1,4-dichlorobenzene, bromobenzene, 1,2-dibromobenzene, 1,3-dibromobenzene, iodobenzene, fluorobenzene, toluene, xylene, phenol, styrene, naphthalene, chloronaphthalene, bromonaphthalene, iodonaphthalene, biphenyl, fluorene, triphenylene, phenanthrene, anthracene, and pyrene.

16. The polyarylborane of claim 1, wherein the substituted polyhedral borane further comprises one or more exohedrally bonded non-aryl substituents.

17. The polyarylborane claim 16, wherein at least one of the exohedrally bonded non-aryl substituents is covalently bonded to a boron cage atoms and said bond is independently selected from the group consisting of a boron-halogen bond, boron-carbon bond, boron-nitrogen bond, boron-phosphorus bond, boron-arsenic bond, boron-sulfur bond, and boron-selenium bond.

18. The polyarylborane of claim 17, wherein the exohedrally bonded non-aryl substituents are independently selected from the group consisting of carboxyls, alkyls, alkenyls, alkynyls, alkoxys, epoxys, hydroxys, acyls, carbonyls, aldehydes, carbonate esters, carboxylates, ethers, esters, hydroperoxides, peroxides, carboxamides, amines, imines, imides, azides, azos, cyanates, isocyanates, nitrates, nitriles, nitrites, nitros, nitrosos, pyridyls, phosphinos, phosphates, phosphonos, sulfos, sulfonyls, sulfinyls, sulfhydryls, thiocyanates, disulfides, silyls, and alkoxy silyls.

19. The polyarylborane of claim 16, wherein the exohedrally bonded non-aryl substituents are independently selected from the group consisting of C₁ to C₂₀ n-alkyl, a C₁ to C₁₂ n-alkyl, a C₁ to C₈ n-alkyl, a hydroxy, a carboxy, an epoxy, an isocyanate, a cyanurate, a primary amine, a silyl, and an alkoxy silyl.

20. A molecule comprising the polyarylborane of claim 1.

21. A composition comprising the polyarylborane of claim 1.

22. A polymer comprising the polyarylborane of claim 1.

23. A photocatalyst comprising the polyarylborane of claim 1.

24. An electroluminescent material comprising the polyarylborane of claim 1.

25. A polymerizable monomer comprising the polyarylborane of claim 1.

26. A non-linear optical material comprising the polyarylborane of claim 1.

27. A molecular electronic material comprising the polyarylborane claim 1.

28. A method of producing a polyarylborane that comprises a substituted polyhedral borane comprising at least 3 exohedrally bonded aryl groups, wherein the substituted polyhedral borane is homo- or hetero-, and each exohedrally bonded aryl group is independently homo- or hetero-, substituted or unsubstituted, and monocyclic or polycyclic, the method comprising heating a reaction mixture that comprises a liquid phase solvent and a solute polyhedral borane in the solvent, wherein the solvent comprises one or more arenes, to react at least one of the polyhedral boranes and at least one of the arenes for a duration sufficient to form the substituted polyhedral borane comprising at least 3 exohedrally bonded aryl groups, wherein the polyhedral borane is homo- or hetero-, and the arene is homo- or hetero-, substituted or unsubstituted, and monocyclic or polycyclic.

29. The method of claim 28, wherein the one or more arenes are selected from the group consisting of benzene, chlorobenzene, 1,2-dichlorobenzene, 1,3-dichlorobenzene, 1,4-dichlorobenzene, bromobenzene, 1,2-dibromobenzene, 1,3-dibromobenzene, iodobenzene, fluorobenzene, toluene, xylene, phenol, styrene, naphthalene, chloronaphthalene, bromonaphthalene, iodonaphthalene, biphenyl, fluorene, triphenylene, phenanthrene, anthracene, pyrene, and combinations thereof;
wherein the polyhedral borane is selected from the group consisting of closo-dodecahydrododecaborate ([B₁₂H₁₂]²⁻); closo-dodecahydrododecaborate ([B₁₀H₁₀]²⁻); o-, m-, and p-dicarbdecahydrododecaboranes; carboranes (C₂B₁₀H₁₂); nido-decaborane (B₁₀H₁₄); and combinations thereof; and
wherein the reaction mixture is heated to a temperature in the range of about 150° C. to about 220° C. at a pressure sufficient to substantially maintain the solvent in its liquid phase.
